(19) United States
(12) Patent Application Publication
(10) Pub. No.: US 2025/0247326 A1
(43) Pub. Date: Jul. 31, 2025

(54) Local Bias Support For Multiprotocol Label Switching Networks

(71) Applicant: Arista Networks, Inc., Santa Clara, CA (US)

(72) Inventors: Prashant Srinivas, San Jose, CA (US); Rajesh Semwal, San Ramon, CA (US); Ramakrishnan Ganapathy Iyer, Thiruvananthapuram (IN); Santosh Kumar, Morgan Hill, CA (US); Sudip Regmi, San Ramon, CA (US); Vijay Mahadevan, Milpitas, CA (US)

(73) Assignee: Arista Networks, Inc., Santa Clara, CA (US)

(21) Appl. No.: 18/428,525

(22) Filed: Jan. 31, 2024

(51) Int. Cl. H04L 45/16; H04L 45/50

(52) U.S. Cl. CPC H04L 45/16; H04L 45/50

(57) ABSTRACT

An ingress provider edge (IPE) device of a provider network receives a packet from outside of the provider network. The IPE device determines the packet is to be transmitted to a device on an Ethernet segment on which the IPE device is multihomed. The IPE device transmits the packet on the Ethernet segment even though the designated forwarder for the Ethernet segment is from IPE device. Furthermore, the IPE device labels the packet with an IPE identifier that identifies the IPE device for the packet, and forwards the labeled packet to other devices on the provider network. An egress provider edge (EPE) device that is (a) multihomed on the same Ethernet segment as the IPE device and (b) is the designated forwarder for the Ethernet segment receives the packet. The EPE device refrains from transmitting the packet on the Ethernet segment.

### TECHNICAL FIELD

The present disclosure relates to optimization of network routing for Multiprotocol Label Switching (MPLS) networks. In particular, the present disclosure relates to managing local bias for multihomed devices in MPLS networks.

### BACKGROUND

In some Ethernet virtual private networking (EVPN) networks, two or more provider edge devices are “multihomed” on a same Ethernet segment. Each of the two or more provider edge devices, multihomed on the same Ethernet segment, may include functionality to forward packets on the Ethernet segment to target destination devices on that Ethernet segment. One of the two or more provider edge devices may be designated as the “designated forwarder” that forwards the packets onto the Ethernet segment to avoid duplicative forwarding on the Ethernet segment by multiple provider edge devices that are multihomed on the same Ethernet segment.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a block diagram of an example network environment for distributing multicast traffic in accordance with one or more embodiments;

FIGS. 2, 3A, and 3B illustrate example sets of operations for managing local bias traffic transmitted multihomed devices in accordance with one or more embodiments;

FIG. 4 illustrates block diagram of an example data packet header in accordance with one or more embodiments; and

FIG. 5 illustrates a block diagram of a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present disclosure.
1. INTRODUCTION
2. GENERAL OVERVIEW
3. GLOSSARY
4. NETWORK ENVIRONMENT
5. MULTIHOME ROUTING PROCESSES
6. EXAMPLE PACKET HEADER
7. COMPUTER NETWORKS AND CLOUD NETWORKS
8. HARDWARE OVERVIEW
9. MISCELLANEOUS; EXTENSIONS

### 1. Introduction

Multiprotocol Label Switching (MPLS) is a networking technology that routes packets based on “labels,” rather than network addresses. Provider edge (PE) devices, including MPLS devices, assign labels to each data packet, which control the packets' paths through the network. MPLS can be used to establish tunnels that distribute multicast traffic across a network by replicating individual packets and routing the copies to multiple receivers. For example, MPLS can be used to multicast a live Internet Protocol (IP) Television (IPTV) channel for simultaneous viewing by many users.

Ethernet virtual private networking (EVPN) is a technology that extends Layer 2 Ethernet connectivity over MPLS networks. In some EVPN networks, destination devices (e.g., a customer's server) are “multihomed” with two or more provider edge devices providing redundant connections. Accordingly, the multihomed destination devices can maintain communication with the network in the event that a provider edge device fails. When a destination device is multihomed using EVPN, the set of Ethernet links connecting the destination device to the edge devices is referred to as an Ethernet segment (ES). In the multihoming configuration, all of the redundant provider edge devices have advertised routes for the Ethernet segment and a multihomed destination device. The provider edge devices in the EVPN session are configured to send traffic destined for the multihomed destination device to the Ethernet segment via either of the redundant provider edge devices. To prevent redundant traffic, one provider edge device, referred to as the “designated forwarder” (DF), is assigned the primary role for forwarding traffic to the destination device.

An Ethernet segment may be a broadcast domain or a Layer 2 Ethernet network segment extended over an MPLS-based infrastructure. In the context of an EVPN network, an Ethernet segment represents an extended Ethernet broadcast domain spanning multiple provider edge devices of the EVPN network. Devices within the same Ethernet segment can communicate with each other as if they were connected to the same local Ethernet LAN.

### 2. General Overview

In one or more embodiments, an ingress provider edge (IPE) device forwards packets on an Ethernet segment even though the designated forwarder for the Ethernet segment is different from the IPE device. In an example, two or more PE devices of a provider network are “multihomed” on a same Ethernet segment. Each of the PE devices, multihomed on the same Ethernet segment, may include functionality to forward packets on the Ethernet segment to target destination devices on that Ethernet segment. One of the PE devices may be a designated forwarder that transmits packets, destined for the Ethernet segment, on the Ethernet segment. When a packet is received by a PE device (referred to as the “IPE device”) from outside of the provider network, the IPE device determines whether the packet is to be transmitted on the Ethernet segment. The IPE device may determine that the packet is to be transmitted on the Ethernet segment based on a determination that a device on the Ethernet segment is associated with a multicast group address corresponding to the packet. In response to determining that the packet is to be transmitted on the Ethernet segment, the IPE device transmits the packet on the Ethernet segment even if the IPE device is not the designated forwarder for the Ethernet segment. This transmission by the IPE device is advantageously faster than the packet being forwarded by the IPE device to the designated forwarder for the Ethernet segment, and the designated forwarder then transmitting the packet on the Ethernet segment.

In one or more embodiments, an IPE device of a provider network labels packets with an IPE identifier that identifies the IPE device, and forwards the labeled packet to other devices on the provider network. As an example, when the IPE device receives a packet from outside of the provider network, the IPE device may add a Multiprotocol Label Switching (MPLS) label to the packet. The Multiprotocol Label Switching (MPLS) label may include a MPLS header with an IPE identifier that identifies the IPE device. The IPE device then forwards the labeled packet to other devices on the provider network. Other devices on the provider network may, based on the IPE identifier, determine the IPE device that first received the packet from outside of the provider network. Other devices may forward, refrain from forwarding, or otherwise process the packet based on the IPE identifier identifying the IPE device.

In one or more embodiments, an egress provider edge (EPE) device of a provider network transmits or refrains from transmitting a packet on an Ethernet segment based at least in part on the IPE device of the provider network that is identified by the packet. When an EPE device of a provider network receives a packet, the EPE device determines (a) whether the packet is to be transmitted to a device on an Ethernet segment on which the EPE device is multihomed, (b) whether the EPE device is the designated forwarder for the Ethernet segment, and (c) whether the IPE device identified by the packet is multihomed on the same Ethernet segment. The EPE device forwards the packet on the Ethernet segment if (a) the packet is to be transmitted to a device on the Ethernet segment, (b) the EPE device is the designated forwarder for the Ethernet segment, and (c) the IPE device identified by the packet is not multihomed on the same Ethernet segment. The EPE device refrains from forwarding the packet on the Ethernet segment if the packet is not to be transmitted to any device on the Ethernet segment. The EPE device refrains from forwarding the packet on the Ethernet segment if the EPE device is not the designated forwarder for the Ethernet segment. Furthermore, the EPE device refrains from forwarding the packet if the IPE device identified by the packet is multihomed on the same Ethernet segment. Accordingly, even if the EPE device is the designated forwarder for an Ethernet segment and the packet is to be transmitted to a device on the Ethernet segment, the EPE device refrains from forwarding the packet on the Ethernet segment based on the IPE device being multihomed on the same Ethernet segment. This refraining, by the EPE device, helps avoid duplicative forwarding on the Ethernet segment since the IPE device (non-designated forwarder) is forwarding the packet on the Ethernet segment.

One or more embodiments described in this Specification and/or recited in the claims may not be included in this General Overview section.

### 3. Glossary

Example definitions of components and concepts, as referenced herein, are included below for ease of understanding. The example definitions are not intended to be complete or necessary. The example definitions should not be construed to limit the scope of the claims.

A Provider Network, as referred to herein, may include a computing network infrastructure managed and/or operated by a network service provider to communicate with customers. Services can include, for example, Internet, virtual private networks (VPNs), cloud services, voice over IP (VOIP), content streaming, and the like. A provider network can include network devices, such as routers, switches, firewalls, load balancers, and other networking equipment functioning together to communicate packets between source devices and receiver devices.

A Packet, as referred to herein, may include a segment of data comprising a sequence of binary digits, including data and control signals arranged in a specific format that can be sent from one computer or network device to another computer or network device over a provider network. Packets may contain such information as its source, destination, size and other information used by network devices to route the packet to the destination. A packet may include a header and a payload.

A Packet Header, as referred to herein, may be a component of a packet including fields containing information for routing, forwarding, and processing the packet by network devices along a route. An example packet header can include one or more of a source address, destination address (e.g., MAC addresses and IP addresses), packet length, protocol information (e.g., TCP, UDP, ICMP, MPLS, etc.), time to live (TTL), checksum or cyclical redundancy check information, fragmentation information, and quality of service (QOS) information (e.g., flags).

A Packet Payload, as referred to herein, may be a component of a packet including data being carried by a packet from a source to a destination. For example, a payload of a packet for Web browsing may contain data encoding content of a web page, images, scripts, and other resources. The payload of a packet for file transfer may contain a document, image, video, or any other type of file. The payload of a packet for a streaming session may contain compressed frames of a video.

A Customer, as referred to herein, may be an organization or individual subscribed to the services of a provider network. A customer can use the provider network to access various content and services, and to communicate with other networks and devices. A customer can include, for example, an enterprise that operates offices, data centers, and remote locations. A customer can also include a business using the provider networks for internet connectivity, cloud services, Virtual Private Networks (VPNs), and other networking solutions, data centers that host websites, applications, content servers, and cloud services. And a customer can include an individual using the provider network to access the World Wide Web, content streaming, and other online services.

An MPLS Network, as referred to herein, may be a telecommunications network operating at the OSI Layer 2.5, between Layer 2 (Data Link Layer) and Layer 3 (Network Layer). MPLS networks assign MPLS labels to packets, which are used to determine forwarding paths through an MPLS network from an IPE device to an EPE device.

A Customer Edge Device, as referred to herein, may include a device at the edge of a provider network that is owned, operated, and/or managed by a customer of a provider network. Customer edge devices can include routers, switches, or other networking devices.

A Provider Edge Device (“PE device”), as referred to herein, may include a device at the edge of a provider network serving as an ingress provider edge device for packets entering the provider network and/or as an egress provider edge device for packets exiting the provider network. A PE device can connect the provider network with a customer edge device. A PE device may receive a packet into the provider network from the customer edge device and route the packet through a particular path through the provider network to a second PE device. The packet may then be transmitted from the second PE device to a second customer edge device, which may then transmit the packets to the target device.

An ingress provider edge device (“IPE device”), as referred to herein, may include a PE device in a provider network that receives a packet from outside of the provider network. In the context of MPLS networks, the IPE device assigns MPLS labels to incoming packets received from, for example, a customer edge device. The MPLS labels determine how the traffic should be routed within the provider network. Additionally, the IPE device learns routes associated with individual customers through routing protocols or static configurations and advertises the routes to other PE devices within the provider network using protocols, such as Border Gateway Protocol (BGP).

An egress provider edge device (“EPE device”), as referred to herein, may include a PE device in a provider network that transmits a packet out of the provider network. An EPE device may receive customer packets directed to a destination that have been routed through the provider network and forward the packets out of the provider network to a customer edge device. In the context of MPLS networks, an EPE device removes MPLS labels from packets transmitted through the network before the packets are sent to a customer edge device.

A Node, as referred to herein, may include a router or switch device located in a provider network. The nodes may forward MPLS-labeled packets based on the information contained in MPLS labels.

A routing table, as referred to herein, is a table maintained by a router in the provider network that maps incoming MPLS labels to EPE devices. Routers use the table to determine how to forward packets through the provider network based on the MPLS labels. The routing table can include, for example, a Label Forwarding Information Base (LFIB).

An MPLS Header, as referred to herein, is a type of packet header used in MPLS networks. The MPLS header contains a label field, experimental field, a bottom of stack field, and Time-to-Live (TTL) field, which includes information used by routers of an MPLS network to forward packets along predetermined paths. The label field includes an MPLS label (e.g., 20 bits) assigned to a packet by an IPE device. The information in the MPLS label indicates a particular forwarding equivalence class (FEC), which is a group of packets that share the same path and treatment within an MPLS network. The experimental field includes information used to specify Quality of Service (QOS) metrics, which can indicate different levels of service priority for the packet. The bottom of stack field includes information indicating whether the current MPLS label is the last label in a label stack. The TTL field specifies the maximum number of hops a packet can travel before being discarded.

A Label Switched Path (LSP), as referred to herein, is a predefined path through an MPLS network that is used to forward packets based on MPLS labels. Label switched paths are established and maintained using various signaling protocols such as Label Distribution Protocol (LDP) and RSVP (Resource Reservation Protocol). Label switched paths can be predefined and configured by network administrators to follow specific routes, links, or resources within an MPLS network.

A Control Plane, as referred to herein, controls and manages data traffic transmitted through a provider network. A control plane determines how data should be forwarded, routing, signaling, and configuring network devices. In the context of an MPLS network, the control plane refers to a set of protocols and mechanisms that establish and manage the forwarding of MPLS packets across the network. The control plane manages the creation and maintenance of MPLS routing tables and the exchange of control information among network devices. Control plane protocols, such as the Label Distribution Protocol (LDP) and Resource Reservation Protocol (RSVP), are responsible for distributing labels among network devices. Labels are assigned to individual network paths and are used to identify the forwarding treatment for MPLS packets. The control plane protocols facilitate the establishment of Label Switched Paths (LSPs). The control plane protocols populate the Label Forwarding Information Base (LFIB) in MPLS-enabled routers. The LFIB contains the mapping between incoming labels and outgoing interfaces or next hops, controlling forwarding of MPLS packets. The control plane protocols exchange routing information among MPLS routers. This includes exchanging network reachability information, network topology, and other relevant routing updates. Examples of routing protocols used in the control plane include OSPF (Open Shortest Path First), IS-IS (Intermediate System to Intermediate System), and BGP.

A Data Plane, as referred to herein, forwards and transmits data packets within a provider network from one device to another. In the context of an MPLS network, the data plane forwards packets through Label Switched Paths (LSPs) of the MPLS network based on MPLS labels.

Multihoming, as referred to herein, may include connecting a single network device, such as a router, to multiple distinct networks. In the context of EVPN networks, a customer edge device may be multihomed with multiple PE devices in an Ethernet segment. In some EVPN networks, destination devices (e.g., a customer's server) are “multihomed” with two or more provider edge devices. The two or more provider edge devices provide redundant connections to the destination devices. Accordingly, the multihomed destination devices can maintain communication with the network in the event that an edge device fails. When a destination device is multihomed using EVPN, the set of Ethernet links connecting the destination device to the edge devices is referred to as an Ethernet segment (ES). In the multihoming configuration, all of the redundant provider edge devices have advertised routes for the Ethernet segment and a multihomed destination device. The provider edge devices in the EVPN session are configured to send traffic destined for the multihomed destination device to the Ethernet segment via either of the redundant provider edge devices. To prevent redundant traffic, one provider edge device, referred to as the “designated forwarder” (DF), has the primary role for forwarding traffic to the destination device.

A Link Aggregation Group (LAG), as referred to herein, may be a combination of physical links between network devices into a single logical link. In the context of MPLS networks, multiple physical links (e.g., Ethernet connections) may be aggregated into a single Ethernet segment providing a high-bandwidth connection to the provider network.

Multiprotocol Label Switching (MPLS), as referred to herein, is a protocol used in MPLS networks. When a packet enters an MPLS network, an IPE device assigns an MPLS label based on the destination IP address of the packet. As the labeled packet traverses the MPLS network, each router examines the MPLS label and forwards the packet based on the MPLS label. At each hop, the router can swap the incoming MPLS label with a new label corresponding to the next hop in the route, such that the packet traverses the network along a predefined label-switched path (LSP). In some cases, where multiple label-switched paths are traversed, routers can use a “label stack” to manage the sequence of labels applied and removed at each hop.

A MPLS Tunnel, as referred to herein, may include a means to transmit multicast packets from a source to multiple receivers. In the context of MPLS networks, an MPLS tunnel transmits multicast packets, encapsulated with MPLS labels, from an IPE device to multiple EPE devices. The labeled packets are forwarded through the MPLS network using established Label Switched Paths (LSPs). As packets traverse the MPLS tunnels, routers included in the tunnels may swap the incoming label with a new label that corresponds to the next hop in the predefined path.

A Multicast Packet, as referred to herein, may be a type of packet sent from a single IPE device to multiple EPE devices in a multicast group. The IPE device transmits a packet to a multicast group address, and EPE devices belonging to that multicast group receive the packet.

A Multicast Group, as referred to herein, may be a logical group of destinations or receivers interested in receiving the same multicast traffic. Routers in an MPLS network use protocols like PIM (Protocol Independent Multicast) or LDP (LDP) to distribute labels for the multicast groups. When an IPE device receives a multicast packet for a specific multicast group, it assigns an MPLS label to the packet. Routers in the MPLS network use the MPLS label to forward the multicast packet only to the EPE devices in the specific multicast group.

A Multicast Group Address, as referred to herein, may be an IP address used to identify a group of devices that are interested in receiving multicast traffic. Multicast group addresses are part of the Internet Protocol (IP) suite (e.g., IPv4 and IPv6 address spaces). When sending multicast packets to a specific group, a customer sends the packet to the corresponding multicast group address as the destination IP address. Routers in the provider network use multicast routing protocols to determine the path and distribution of multicast packets to all members of the group. The traffic is forwarded only to devices that have indicated their interest in that multicast group by sending specific signaling messages to the provider network. Devices that have joined the multicast group and are listening to the corresponding multicast group address receive and process the multicast packets.

Ethernet virtual private networking (EVPN) is a technology that extends Layer 2 Ethernet connectivity over MPLS networks.

An Ethernet Segment, as referred to herein, may be a broadcast domain or a Layer 2 Ethernet network segment extended over an MPLS-based infrastructure. In the context of an EVPN network, an Ethernet segment represents an extended Ethernet broadcast domain that spans multiple PE devices of the EVPN network. Devices within the same Ethernet Segment can communicate with each other as if they were connected to the same local Ethernet LAN.

### 4. Network Environment

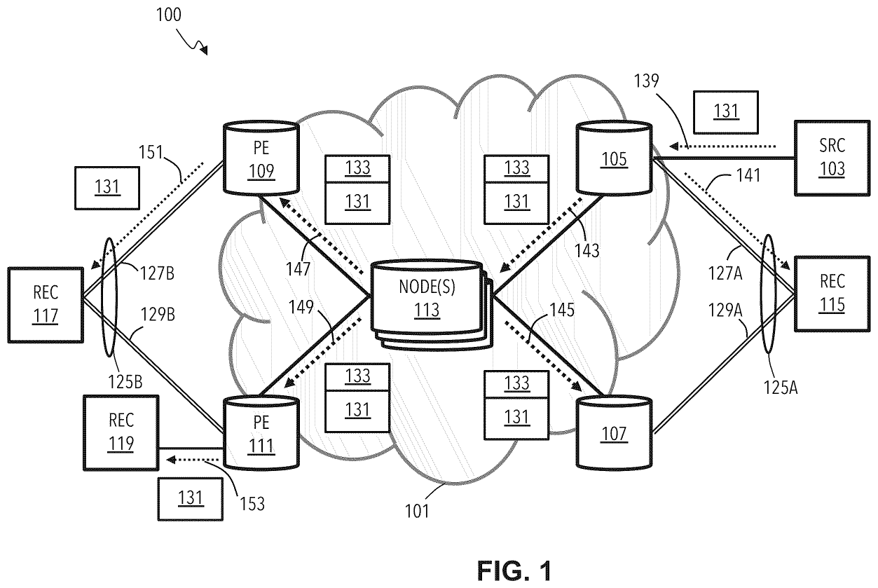

FIG. 1 illustrates an architecture of an example network environment 100 in accordance with one or more embodiments. The network environment 100 includes provider network 101, source (SRC) 103, PE devices 105, 107, 109, 111, nodes 113, receivers (RECs) 115, 117, 119, and Ethernet segments (ESs) 125 communicatively connected, directly or indirectly, via two or more different communication channels 127, 129. In one or more embodiments, the network environment 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The provider network 101 can include an EVPN-MPLS network, including the PE devices 105, 107, 109, 111 and the nodes 113. It is understood that the provider network 101 can include other types of overlay networks, such as a VxLAN. The provider network 101 multicasts copies of packet 131 using MPLS headers 133 in order to make data forwarding decisions for transmitting the copies of the packet 131 to the destination receivers 115, 117, 119.

The PE devices 105, 107, 109, 111 are devices serving as the ingress and egress points for traffic entering or exiting the provider network 101. The PE devices 105, 107, 109, 111 perform functions such as packet labeling, packet forwarding, and policy enforcement. One or more embodiments include provisioning PE labels to the routers comprising the PE devices 105, 107, 109, 111. The respective PE labels can be advertised to the other PE devices 105, 107, 109, 111 and nodes 113 by attaching an extended Integrated Multicast Ethernet Tagging (IMET) route of the provider network 101. IMET routes are a type of multicast forwarding mechanism allowing multicast packets to be transmitted over an Ethernet network, such as ethernet segments 125. The IMET route is not specific to the ethernet segments 125.

The PE devices 105, 107, 109, 111 can store information used for forwarding packets, including MPLS Labels, Routing Information, Customer Routes, Customer-Specific Labels, MPLS Tunnel Information, and MAC Address Tables. The MPLS labels can be maintained in Label Forwarding Information Bases (LFIBs), which are tables containing mappings between incoming MPLS labels and outgoing interfaces and labels. The PE devices 105, 107, 109, 111 can use the information stored in LFIBs to determine how to forward MPLS-labeled packets based on MPLS label values. The routing information can be used to make forwarding decisions for IP packets that are not MPLS-labeled. This includes information about IP prefixes and next-hop routers obtained from routing protocols like OSPF (Open Shortest Path First), BGP, and RIP (Routing Information Protocol). The customer routes can be maintained in a Virtual Routing and Forwarding (VRF) table, which allows for the segregation of customer traffic. The PE devices 105, 107, 109, 111 assign customer specific MPLS labels for routes within each VRF. These labels are used to distinguish routes within different VPNs and to ensure traffic separation. The PE devices 105, 107, 109, 111 may store information related to established MPLS tunnels and their characteristics. for traffic engineering and optimizing the network's use of resources. The PE devices 105, 107, 109, 111 maintain a MAC address table to map Ethernet MAC addresses to specific attachment circuits or VLANs. The PE devices 105, 107, 109, 111 maintain BGP session information with other PE routers to exchange VPN-IPv4 routes and Route Distinguisher (RD) information, which is used to identify the routes of different VPN customers.

The nodes 113 can include, for example, routers, switches, and the like that transport packet traffic through the provider network 101. The source 103 and the receivers 115, 117, and 119 can include devices (e.g., end user devices) outside the provider network 101. For example, the source 103 can include a content source of an Internet Protocol (IP) television channel which is multicast to the receivers 115, 117, 119 via the provider network 101. The receivers 115, 117, and 119 can include devices subscribed or that may subscribe to the source 103 to receive a multicast stream of content.

In the non-limiting example illustrated in FIG. 1, the PE device 105 is communicatively connected to the source 103. The source 103 can include a device or network that generates packets, such as packet 131, for multicasting via a multicast tree through the provider network 101. The PE devices 107, 109, 111 are joined in a multicast MPLS tunnel rooted at the PE device 105 by the nodes 113. As indicated by arrow 139, the PE device 105 receives the incoming packet 131 from the source 103 and labels the packet 131 with an MPLS header 133 identifying the PE device 105 as an ingress PE device (IPE). The packet 131 can include a multicast group address corresponding to receivers 115, 117, 119 subscribed to the source 103. As indicated by arrows 143, 145, 147, 149, and 151, multiple copies of the labeled packet 131 are then forwarded through the provider network 101, for example, using established Label Switched Paths, to the PE devices 107, 109, 111 for transmission to the receivers 115, 117, and 119, respectively.

Additionally, the ingress PE device 105 determines that the multicast group address of the packet 131 is associated with the Ethernet segment 125A including the receiver 115, wherein the receiver 115 is multihomed by the communication channels 127A, 129A to the PE devices 105 and 107 using the Ethernet segment 125A. In the present example, the PE device 107 is the designated forwarder for the Ethernet segment 125A and is, therefore, responsible for forwarding traffic destined for devices on the Ethernet segment 125A, such as receiver 115. When local bias is enabled, the ingress PE (IPE) device 105 forwards the packet 131 directly to the receiver 115, as indicated by arrow 141, even though PE device 107 is the designated forwarder. In other words, embodiments include forwarding the unlabeled packet 131 from the IPE device 105 to the receiver 115 via communication link 127A of the Ethernet segment 125A and not from the designated forwarder PE device 107 via the EVPN-MPLS network. And, responsive to determining the header 133 indicates the PE device 105 is the ingress device in the same Ethernet segment 125A, the PE device 107 refrains from transmitting the labeled packet 131 to the receiver 115.

Furthermore, the PE devices 109 and 111 are multihomed on the ethernet segment 125B by the communication channels 127B, 129B. In the present example, the PE device 109 is the designated forwarder for the Ethernet segment 125B and is, therefore, responsible for forwarding traffic destined for Ethernet segment 125B. As such, responsive to determining that PE device 109 is the designated forwarder for the Ethernet segment 125B, PE device 109 decapsulates packet 131 having label 133 received from one of nodes 113 and forwards the decapsulated packet 131 to the receiver 117 via communication link 127B, as indicated by arrow 151. Furthermore, responsive to determining that PE device 111 is not the designated forwarder for the Ethernet segment 125B, PE device 111 refrains from forwarding the packet 131 to receiver 117. PE device 111, responsive to determining that receiver 119 is subscribed to the source 103, decapsulates packet 131 having label 133 received from one of nodes 113 and forwards the decapsulated packet 131 to the receiver 119, as indicated by arrow 153.

### 5. Multihome Routing Processes

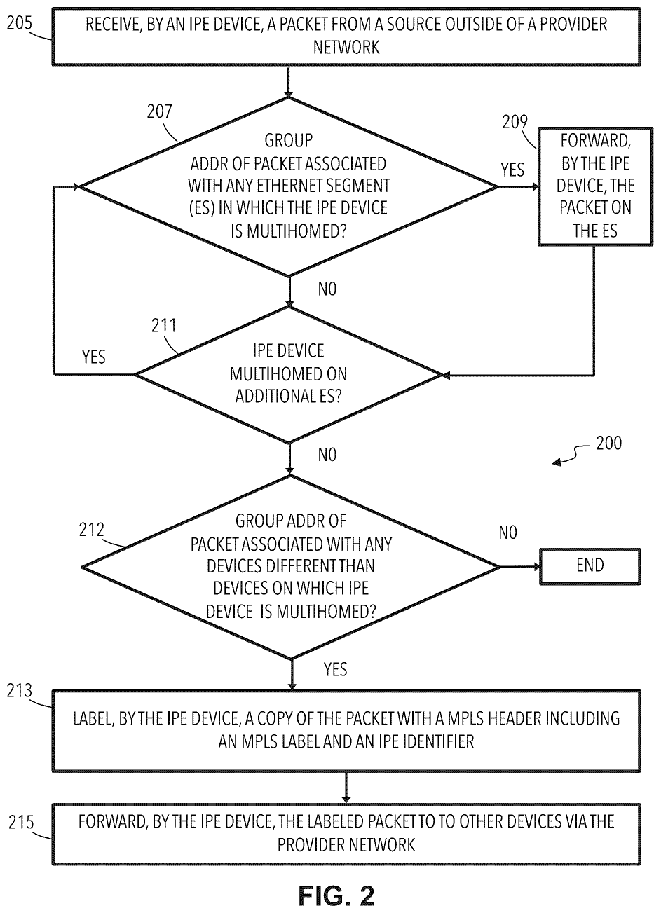

FIG. 2 illustrates an example set of operations for routing packets received from outside a provider network implemented by an IPE device of the provider network, which includes a multihomed receiver on an Ethernet segment. Operations described below with reference to FIG. 2 may be performed, for example, by IPE 105 illustrated in FIG. 1.

One or more operations illustrated in FIG. 2 may be modified, rearranged, or omitted all together. Accordingly, the particular sequence of operations illustrated in FIG. 2 should not be construed as limiting the scope of one or more embodiments. Each block in FIG. 2 can represent a module, segment, or portion of program instructions, which includes one or more computer executable instructions for implementing the illustrated functions and operations. Additionally, each block and combinations of blocks in the flow diagrams can be implemented by special-purpose hardware-based systems that perform the specified functions or acts, or combinations of special-purpose hardware and computer instructions.

At block 205, an IPE device of a provider network, receives a packet from a source outside of the provider network. For example, the IPE device can include a router of an EVPN-MPLS network communicatively coupled to a customer edge device. The customer can include, for example, a content provider that multicasts the packet to multiple destination devices subscribed to content from the customer. The packet can include a multicast group address corresponding to multiple destination addresses subscribed to the content provider.

At block 207, the IPE device determines whether the multicast group address (“ADDR”) of the packet is associated with an Ethernet segment on which the IPE device is multihomed. The determination can include evaluating whether the multicast group address or destination of the packet comprises any device on an Ethernet segment. Additionally, the IPE device can determine whether the IPE device is multihomed in the Ethernet segment based on configuration information and route information. An administrator or operator of the provider network can set the configuration information. The configuration information can define whether an IPE device is multihomed with other PE devices. The configuration information can include, for example, IP addresses, and BGP parameters. A control plane of the provider network can advertise the route information using routing protocols (e.g., BGP signaling), which can be stored by the IPE device in a routing table. The route information can include attributes indicating whether the PE device is multihomed, such as Autonomous System (AS) Path, BGP Community or Extended Community Values, and advertised IP prefixes. For example, a customer edge device multihomed with multiple PE devices can use BGP to advertise routes to both PE devices. As a result, the routing tables of the PE devices will include two BGP routes to the same destination address, but with different next-hop addresses corresponding to each PE device. In an example, the routing table can include: destination address 192.168.0.0/24; next hop 10.0.0.1; and next hop 10.0.0.2. Thus, PE devices can include an EPE device is multihomed with other PE devices and can include information, such as IP addresses, and BGP parameters.

If the IPE device determines the multicast group address of the packet is associated with an Ethernet segment on which the IPE device is multihomed (e.g., block 207 is “Yes”), then at block 209, the IPE device forwards the packet on the Ethernet segment. In some embodiments, the IPE device is a designated forwarder for the Ethernet segment. Embodiments include forwarding the packet to the receiver device via the Ethernet segment without adding an MPLS header to the packet for communication through the provider network. The IPE device can identify the destination devices on the Ethernet segments using Ethernet addressing, such as Media Access Control (MAC) addresses.

Alternatively, the IPE device may determine that the multicast group address of the packet is not associated with an Ethernet segment on which the IPE device is multihomed (e.g., block 207 is “No”). The system repeats the operations 207 and 209 for each Ethernet segment on which the IPE device is multihomed by identifying any additional Ethernet segments at block 211. The IPE device can identify the additional Ethernet segments based on configuration information set by an administrator or manager and route information advertised by a control plane of the provider network using routing protocols.

In an embodiment, the IPE device determines whether the multicast group address of the packet is associated with any device different from the devices on which the IPE device is multihomed. In an example, the system tracks all of the requests to join a multicast group. Based on the join requests, the system identifies subscribers associated with a multicast group address corresponding to the multicast group. If the group address of the packet is not associated with any devices that are different from the devices on which the IPE device is multihomed (e.g., block 212 is “No”), then the process 200 ends. If the multicast group address of the packet is associated with at least one device different from the devices on which the IPE device is multihomed (e.g., block 212 is “Yes”), then the process 200 proceeds to block 213.

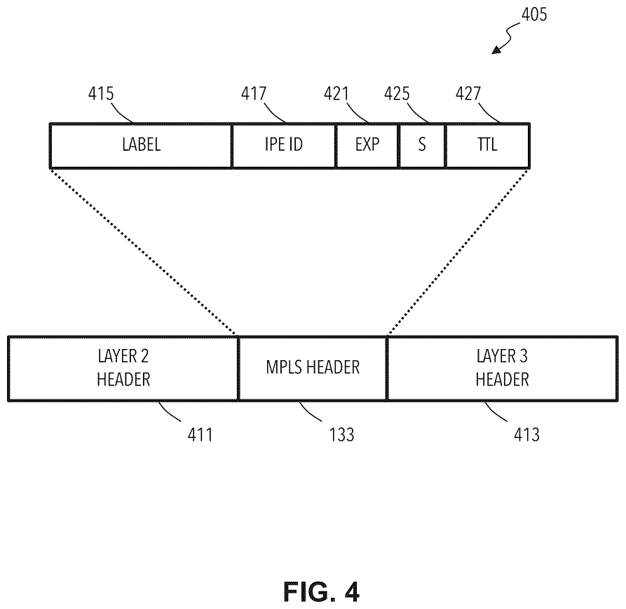

At block 213, the IPE device adds an MPLS header to a copy of the packet. The MPLS header can include an MPLS label (e.g., label 415 in FIG. 4) and an IPE identifier (e.g., IPE identifier 417 in FIG. 4). The IPE device can add the MPLS label by determining a forwarding path for the packet based on the destination IP address of the packet using a multicast routing table. The MPLS label corresponds to a Forwarding Equivalence Class (FEC) indicating a particular route or a particular set of routes for the packet through the provider network. The identifier of the IPE device is a value, such as a MAC address, uniquely identifying the PE device that received the packet at block 205 as the IPE device. For example, referring to FIG. 1, the PE identifier can identify PE device 105 as the IPE device that received the packet 131 into the provider network 101 from source 103. The IPE device inserts the MPLS label and IPE identifier onto the packet before the IP header (e.g., Layer 3 header 413 in FIG. 4) such that the original IP header is preserved within the packet.

At block 215, the IPE device forwards the packet, as labeled with an MPLS header at block 213, to other devices on the provider network based on the MPLS label. As previously described, the nodes of the provider network use the MPLS label to determine the path of the packet. Each node examines the MPLS label and swaps the label according to the node's label routing table. The forwarding and swapping process continues until the packet reaches an EPE device (e.g., one or more of PE devices 107, 109, 111).

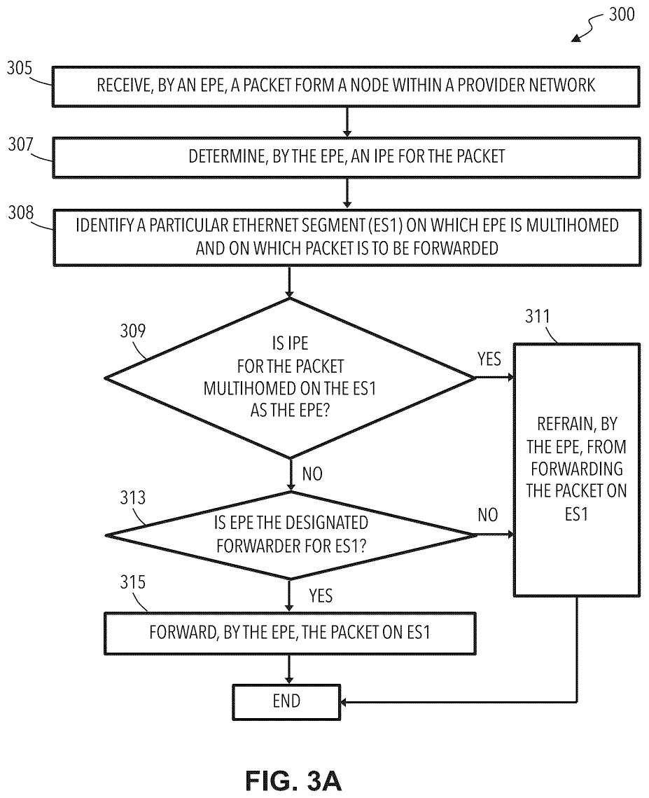

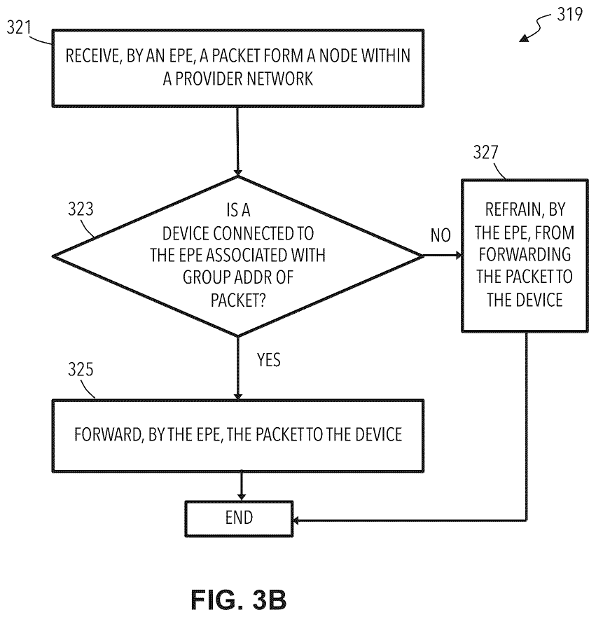

FIGS. 3A and 3B illustrate example sets of operations for PE devices of a provider network, forwarding packets out of the provider network. The example sets of operations may be performed by a PE device that receives a MPLS-labeled packet from another PE within the provider network. FIG. 3A illustrates a set of operations that may be performed, for example, by PE 109 or PE 107 in FIG. 1. FIG. 3B illustrates a set of operations that may be performed, for example, by PE 111 in FIG. 1.

One or more operations illustrated in FIGS. 3A and 3B may be modified, rearranged, or omitted all together. Accordingly, the particular sequence of operations illustrated in FIGS. 3A and 3B should not be construed as limiting the scope of one or more embodiments. Each block in FIGS. 3A and 3B can represent a module, segment, or portion of program instructions, which includes one or more computer executable instructions for implementing the illustrated functions and operations. Additionally, each block and combinations of blocks in the flow diagrams can be implemented by special-purpose hardware-based systems that perform the specified functions or acts, or combinations of special-purpose hardware and computer instructions.

FIG. 3A illustrates an example set of operations of a process 300 executed by a PE in a provider network for routing packets to devices outside a provider network. At block 305, an EPE device on a provider network receives a MPLS-labeled packet from an IPE device via one or more nodes in the provider network. The packet can have an MPLS header including an MPLS label and an IPE identifier.

At block 307, the EPE device determines the IPE device for the packet using the IPE identifier within an MPLS header of the packet received at block 305. The EPE device can identify the IPE device by comparing the IPE identifier with route information maintained by the EPE device. For example, the EPE device can maintain a multicast routing table or the like that stores routing information learned from routing protocols (e.g., Border Gateway Protocol) executed by a control plane and/or advertised by other PE devices within the provider network. A multicast routing table is a data structure used by routers to manage and make forwarding decisions for multicast traffic in a network. Multicast routing tables store information associating multicast groups with, for example, sources, and the outgoing interfaces for forwarding multicast traffic to the members of groups. The multicast group identifies the multicast group addresses for which the PE is forwarding traffic. The sources identify addresses (e.g., IP addresses) of sources of multicast traffic for each group. The outgoing interfaces indicate the network interfaces or next hops where the multicast traffic should be forwarded to reach the receivers of each group. Using the multicast routing table, the EPE device can identify an IPE device for the packet.

At block 308, the EPE device identifies a particular Ethernet segment (referred to as “ES1”) on which the EPE device is multihomed and on which the packet is to be forwarded. The EPE device determines that the packet is to be forwarded on ES1 by determining that the packet is to be transmitted to a device on ES1. In an example, the EPE device determines that the packet corresponds to a multicast group associated with a device on ES1. FIG. 3A illustrates the process 300 for one Ethernet segment. It is understood that the provider network can include more than one Ethernet segment and the process 300 can repeat for every Ethernet segment identified at block 308 on which the EPE device is multihomed.

At block 309, the EPE device determines whether the IPE device determined at block 307 is multihomed on the same Ethernet segment, ES1 as the EPE device. The EPE device can make the determination based on configuring information set by an administrator or operator of the provider network and route information advertised by a control plane of the provider network, as previously described above with respect to block 207 of FIG. 2. If the EPE device determines the IPE device for the packet is multihomed on the same Ethernet segment, ES1 as the EPE device (e.g., block 309 is “Yes,”), then the EPE device refrains from forwarding the packet on the Ethernet segment (block 311). As an example, PE 107, in FIG. 1, refrains from forwarding the packet on Ethernet segment 125A since the IPE device 105, for the packet received by PE 107, is multihomed on the same Ethernet segment 125A.

If the EPE device determines the IPE device for the packet is not multihomed on ES1 (e.g., block 309 is “No,”), then at block 313, the EPE device determines whether the EPE device is the designated forwarder for ES1. As previously described, the designated forwarder in the provider network is responsible for communicating Ethernet frames with the Ethernet segment. Within each Ethernet segment, the designated forwarder is elected by the PE devices connected to the Ethernet segment based on, for example, priority and load metrics relative to other PE devices connected to the Ethernet segment. The identification of the designated forwarder can be advertised by the control plane of the provider network (e.g., using EVPN Type 2 and Type 3 routes) and stored by the PE devices in multicast routing tables or the like.

If the EPE device is not the designated forwarder for ES1 (e.g., block 313 is “No,”), then the EPE device refrains from forwarding the packet on the Ethernet segment (block 311). If the EPE device is determined to be the designated forwarder for ES1 (e.g., block 313 is “Yes,”), then at block 315, the EPE device forwards the packet on the Ethernet segment. The EPE device for the Ethernet segment can forward the packet to the destination on the Ethernet segment by removing the MPLS header, examining the inner Ethernet information of the packet (e.g., Layer 2 header 411), and forwarding the unlabeled packet to the destination based on the Ethernet information using Ethernet protocol based on, for example, a MAC address table. As an example, with respect to FIG. 1, PE 109 forwards the packet on Ethernet segment 125B because (a) the IPE 105 is not multihomed on Ethernet segment 125B and (b) PE 109 is the designated forwarder for Ethernet segment 125B.

As stated above, FIG. 3B illustrates an example set of operations for a PE device, of a provider network, forwarding packets out of the provider network. The example sets of operations may be performed by a PE device that receives a MPLS-labeled packet from another PE within the provider network. FIG. 3B illustrates a set of operations that may be performed, for example, by PE 111 in FIG. 1 that is directed connected to receiver 119.

At block 321, an EPE device in a provider network receives a MPLS-labeled packet from an IPE device via one or more nodes in the provider network. The packet can have an MPLS header including an MPLS label. At block 323, the EPE device determines whether any device that is connected to the EPE is associated with the group address of the packet. As previously described, the device may be associated with a particular group address based on subscribing to content or other information from a source connected to the IPE device.

If the EPE device determines that there is a device connected to the EPE device associated with the group address of the packet (e.g., block 323 is “Yes”), then at block 325, the EPE device forwards the packet to the device. For example, referring to FIG. 1, PE 111 would forward the packet 131 to receiver 119 when the receiver 119 is associated with a group address of the packet 131. On the other hand, if the EPE device determines that there is no device connected to the EPE associated with the group address of the packet (e.g., block 323 is “No”), then at block 327, the EPE device refrains from forwarding the packet.

### 6. Example Packet Header

FIG. 4 illustrates a block diagram of an example packet header 405 in accordance with one or more embodiments. The packet header 405 includes an OSI Layer 2 header 411, an MPLS header 133, and an OSI Layer 3 header 413. The Layer 2 header 411 contains information used for addressing, framing, error detection, and medium access control (MAC) using, for example, Ethernet protocol. The Layer 3 header 413 includes information used by routers for addressing, routing, and forwarding of a packet across one or more networks. The MPLS header 133 includes information used by routers of an MPLS network (e.g., provider network 101) for routing and forwarding of the packets across the MPLS network. As illustrated by the breakout of the MPLS header 133 in FIG. 4, the MPLS header 133 can comprise labels bits 415, experimental bits (EXP) 421, a Bottom of Stack(S) bit 425, and Time-to-Live (TTL) bits 427, which can include the same as those previously described above. The IPE identifier 417 is a value uniquely identifying the IPE device as the IPE device for the packet. For example, the IPE identifier 417 can include a MAC address of the PE device.

### 7. Computer Networks and Cloud Networks

In one or more embodiments, a computer network (e.g., provider network 101) provides connectivity among a set of nodes (e.g., nodes 113). The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

The computer network may be an overlay network, such as an MPLS network or a VxLAN. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client (e.g., source 103 and receivers 115, 117, 119) may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

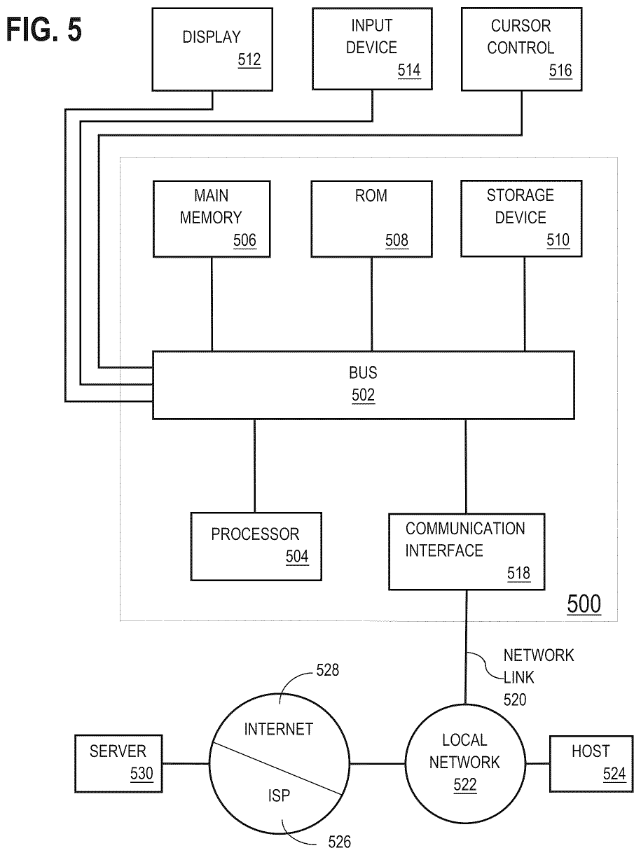

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor 504 as it is received, and/or stored in storage device 510, or other non-volatile storage for later execution.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause the one or more hardware processors to perform operations comprising:
receiving, by an ingress provider edge (IPE) device of a provider network, a packet from a source device outside of the provider network, wherein:
the IPE device is an ingress device receiving the packet into the provider network, and
the packet includes a multicast group address;
determining whether the multicast group address of the packet is associated with any Ethernet segment on which the IPE device is multihomed; and
responsive to determining that the multicast group address of the packet is associated with an Ethernet segment on which the IPE device is multihomed: forwarding, by the IPE device, the packet on the Ethernet segment.

2. The one or more non-transitory computer readable media of claim 1, wherein the IPE device comprises a designated forwarder for the Ethernet segment.

3. The one or more non-transitory computer readable media of claim 1, wherein:
the operations further comprise determining that the multicast group address of the packet is associated with the Ethernet segment on which the IPE device is multihomed; and
a designated forwarder, for the Ethernet segment on which the IPE device is multihomed, is different from the IPE device.

4. The one or more non-transitory computer readable media of claim 1, wherein the operations further comprise:
labeling, by the IPE device, the packet with a Multiprotocol Label Switching (MPLS) label comprising an IPE identifier that identifies the IPE device; and
forwarding, by the IPE device, the packet labeled with the MPLS label to one or more devices within the provider network.

5. The one or more non-transitory computer readable media of claim 4, wherein the MPLS label comprises a Forwarding Equivalence Class (FEC) indicating one or more routes for the packet through the provider network.

6. The one or more non-transitory computer readable media of claim 1, wherein determining whether the multicast group address of the packet is associated with any Ethernet segment on which the IPE device is multihomed comprises:
evaluating whether the multicast group address is associated with any device on any Ethernet segment on which the IPE device is multihomed.

7. The one or more non-transitory computer readable media of claim 1, wherein determining that the multicast group address of the packet is associated with the Ethernet segment on which the IPE device is multihomed is based on configuration information and route information.

8. The one or more non-transitory computer readable media of claim 1, wherein a second PE device, multihomed on the Ethernet segment, does not forward the packet on the Ethernet segment even though the second PE device is the designated forwarder for the Ethernet Segment.

9. One or more non-transitory computer readable media comprising instructions which, when executed by one or more hardware processors, cause the one or more hardware processors to perform operations comprising:
receiving, by an ingress provider edge (IPE) device of a provider network, a packet from a source device outside of the provider network, wherein:
the IPE device is an ingress device receiving the packet into the provider network, and
the packet includes a multicast group address;
determining whether the multicast group address of the packet is associated with any Ethernet segment on which the IPE device is multihomed;
responsive to determining that the multicast group address of the packet is associated with an Ethernet segment on which the IPE device is multihomed: forwarding, by the IPE device, the packet on the Ethernet segment; and
labeling, by the IPE device, the packet with a Multiprotocol Label Switching (MPLS) label comprising an IPE identifier that identifies the IPE device; and
forwarding, by the IPE device, the packet labeled with the MPLS label to one or more devices within the provider network.

10. The one or more non-transitory computer readable media of claim 9, wherein a designated forwarder, for the Ethernet segment, is different from the IPE device.

11. The one or more non-transitory computer readable media of claim 9, wherein determining that the IPE device is associated with the Ethernet segment is based on configuration information and route information.

12. The one or more non-transitory computer readable media of claim 9, wherein determining whether the multicast group address of the packet is associated with any Ethernet segment on which the IPE device is multihomed comprises:
evaluating whether the multicast group address is associated with any device on any Ethernet segment on which the IPE device is multihomed.

13. The one or more non-transitory computer readable media of claim 9, wherein the IPE identifier is included in a MPLS header of the MPLS label.

14. The one or more non-transitory computer readable media of claim 9, wherein the MPLS label comprises a Forwarding Equivalence Class (FEC) indicating one or more routes for the packet through the provider network.

15. One or more non-transitory computer readable media comprising instructions which, when executed by one or more hardware processors, cause the one or more hardware processors to perform operations comprising:
receiving, by an egress provider edge (PE) device of a provider network, a first packet labeled with a first MPLS label comprising a first IPE identifier that identifies a first IPE device of the provider network that received the first packet from outside of the provider network, wherein the first packet includes a first multicast group address;
determining whether the first multicast group address of the first packet is associated with any Ethernet segment on which the EPE device is multihomed;
determining that the first multicast group address of the first packet is associated with a first Ethernet segment on which the EPE device is multihomed;
determining whether the first IPE device, identified by the first IPE identifier, is multihomed on the first Ethernet segment;
responsive to determining that the first IPE device is not multihomed on the first Ethernet segment: forwarding, by the EPE device, the first packet on the first Ethernet segment.

16. The one or more non-transitory computer readable media of claim 15, wherein the EPE device forwards the packet on the Ethernet segment further responsive to determining that the EPE device is a designated forwarder for the Ethernet segment.

17. The one or more non-transitory computer readable media of claim 15, wherein the operations further comprise:
receiving, by the EPE device, a second packet labeled with a second MPLS label comprising a second IPE identifier that identifies a second IPE device of the provider network that received the second packet from outside of the provider network, wherein the second packet includes a second multicast group address;
determining whether the second multicast group address of the second packet is associated with any Ethernet segment on which the EPE device is multihomed;
determining that the second multicast group address of the second packet is associated with a second Ethernet segment on which the EPE device is multihomed;
determining whether the second IPE device, identified by the second IPE identifier, is multihomed on the second Ethernet segment;
responsive to determining that the second IPE device is multihomed on the second Ethernet segment: refraining, by the EPE device, from forwarding the second packet on the second Ethernet segment.

18. The one or more non-transitory computer readable media of claim 17, wherein the EPE device refrains from forwarding the second packet on the second Ethernet segment even though the EPE device is a designated forwarder for the second Ethernet segment.

19. The one or more non-transitory computer readable media of claim 15, wherein the first MPLS label is added to the first packet by the first IPE device after the first IPE device receives the first packet from outside of the provider network.

20. The one or more non-transitory computer readable media of claim 15, wherein determining whether the first multicast group address of the first packet is associated with any Ethernet segment on which the EPE device is multihomed comprises:
evaluating whether the first multicast group address is associated with any device on any Ethernet segment on which the EPE device is multihomed.
